(19) United States
(12) Patent Application Publication
(10) Pub. No.: US 2006/0170986 A1
(43) Pub. Date: Aug. 3, 2006

(54) Screen processing method and image processing apparatus

(75) Inventor: Norio Iriyama, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/340,622

(22) Filed: Jan. 27, 2006

(30) Foreign Application Priority Data
Feb. 3, 2005 (JP) 2005-027887

(51) Int. Cl. H04N 1/04

(52) U.S. Cl. 358/474

(57) ABSTRACT

Disclosed is a screen processing method, comprising: a scanning step of scanning two-dimensionally arranged pixels of an output object image in a main scanning direction and a sub scanning direction so as to extract a pixel value of each pixel; a thresholding step of counting scanning displacements in the main scanning direction and the sub scanning direction according to a screen angle by using two counters working with each other, and of discriminating each pixel position based on counted values of the counting so as to obtain a threshold value of the pixel value corresponding to each pixel position; and an outputting step of referring to a conversion table showing an relation of a output value to an input pixel value, the conversion table corresponding to the obtained threshold value, so as to obtain the multilevel output value corresponding to the extracted pixel value.

### BACKGROUND

1. Field of the Invention

The present invention relates to a screen processing method of forming a halftone dot in an output object image based on each pixel value of the image, and to an image processing apparatus which performs screen processing to the output object image.

2. Description of Related Art

Screen processing for forming halftone dots as a gray scale expression in a digital image has been generally performed. In the screen processing, an angle (the so-called screen angle) formed by an arrangement of the halftone dots is not an arbitrary angle, but has taken an angle θ the tan θ of which becomes a rational number, or an angle taking the so-called rational tangent. When the halftone dots are formed, an output value is determined by repeatedly applying a unit region in the shape of a tile, which region is called as a cell, on an image according to the shape of a screen pattern for forming a halftone dot, and by comparing threshold values previously assigned in a matrix in the cell with each pixel value in the image region to which the cell is applied. In this case when the angles of the four corners of the cell do not agree with the angles of the lattices of the pixel, the same cell cannot be repeatedly applied over the whole image region. That is the reason why the screen angles take the angles being the rational tangent. However, under such a condition, realizable screen angles and the line number of a screen (the density of the arrangement of the halftone dots) are considerably limited.

Moreover, if two or more pattern images in which halftone dots are periodically formed are superposed on one another, the pattern images interfere with one another to generate image noises called as moiré. In order to suppress the moiré, a technique of superposing the halftone dot images while changing their angles has been applied. In case of four colors (of yellow (Y), magenta (M), cyan (C) and black (K)), it is general to superpose halftone dot images of C, M and K while changing their angles severally by 30 degrees, and while changing the Y, which is difficult to be conspicuous, by 15 degrees.

When a desired angle θ is wanted to be obtained in a single cell with good accuracy in consideration of the suppressing of the moiré and the like, the combination of integers m and n to be tan θ ≅n/m (m, n are integers) becomes larger, and the size of the cell becomes larger. A larger cell size makes it possible to take a multi-stage level when a gray scale is expressed. However, if the size becomes too large, the halftone dots to be formed become larger to produce an image having rough image quality.

On the other hand, the so-called super cell system of using a wide region including a plurality of cells having cell sizes delicately different from one another (the region is called as a super cell) as a unit region of repetition processing has been adopted (see, for example, JP Hei10-84477A). In the super cell system, a screen angle is set as each of the angles of the four corners of a super cell so that the angle may agree with the angle of each of the lattices of the pixels. However, because each cell included in the super cell does not always agree with the angle of the lattice of a pixel, the degree of freedom is improved at the time of setting a screen angle.

Moreover, the Holladay algorithm is known as an algorithm for discriminating which position of a threshold value matrix each pixel in a cell to be repeatedly applied at an angle inclined by a screen angle to an image corresponds to, namely discriminating the threshold value corresponding to each pixel (see, for example, Henry R. Kang, “Digital Color Halftoning” (Society of Photo-Optical Instrumentation Engineers, November, 1999)). This is an algorithm using a nature making it possible to convert any screen pattern shapes into rectangles when all the cells to be repeatedly applied have the same sizes and are rational tangent. For example, as shown in FIG. 15, when a cell size is eight and a screen pattern (a region enclosed by a wide line) is in the shape of a windmill, the threshold value table can be expressed by a rectangle of 2×4 in place of the windmill shape (the shape of the threshold value table is expressed by a dotted line in the figure). In this case, the reference positions in the threshold value table (numerals set in the threshold value table) can be determined by the remainder of the division of the number of times of main scanning and the number of times of sub scanning by the rectangle sizes in the main scanning direction and the sub scanning direction, respectively. Then, a threshold value to be referred to can be easily calculated.

Moreover, in case of an electrophotography system of performing image formation by performing exposure development using laser light, multi-value output becomes possible, and a radiation position of laser can be changed in a dot. Accordingly, there has been developed a technique for making it possible to make an apparent angle of a halftone dot arrangement an angle near irrational tangent, though an original screen angle is rational tangent, by selecting the radiation positions of laser and the area of the radiation positions in a dot, and by shifting the center of halftone dots to an arbitrary position (see, for example, JP 2000-228728A).

However, because the method disclosed in JP 2000-228728A uses a fixed screen size of integer pixels x integer pixels, the generation of moiré caused by the agreement of the degree of the overlapping of each color at a certain period has been pointed out. As for the problem, a method of making the row of the dots in the sub scanning direction irrational tangent by differentiating the scanning timing of laser has been known (see, JP 2001-61072A).

However, in the super cell method disclosed in JP Hei10-84477A, a super cell is composed of a plurality of cells having delicately different cell sizes, and consequently the arrangement of uneven cells produces periodicity. Accordingly, the threshold value set in a cell for forming each halftone dot have had to be set not to produce any moiré. Moreover, although the degree of freedom of the setting of a screen angle is larger than that of the system in which a single cell is applied, the screen pattern and the cell also had to be designed so that the super cell itself may be rational tangent, and the design has been complicated.

Moreover, in the case where the Holladay algorithm disclosed in “Digital Color Halftoning” is applied to the case of the irrational tangent or to the case of a micro-cell system in which some of cells having different sizes are combined to be a repetition unit region, or the like, the design of threshold value tables becomes difficult and complicated in some shapes of screen patterns owing to the necessity of the adjustment of the length sizes and the breadth sizes of the rectangles of the threshold value tables and the adjustment of the shifting quantities of the threshold value tables when the tables overlap with one another, and the like.

Moreover, the technique disclosed in JP 2000-228728A is limited to bring the original screen angle close to irrational tangent, and cannot fully realize the irrational tangent.

### SUMMARY

One of the objects of the present invention is to perform screen processing of an arbitrary screen angle with a simple configuration.

In order to achieve one of the above mentioned objects, according to one embodiment reflecting the first aspect of the invention, a screen processing method, comprises:

a scanning step of scanning two-dimensionally arranged pixels of an output object image in a main scanning direction and a sub scanning direction so as to extract a pixel value of each pixel;

a thresholding step of counting scanning displacements in the main scanning direction and the sub scanning direction according to a screen angle by using two counters working with each other, and of discriminating each pixel position based on counted values of the counting so as to obtain a threshold value of the pixel value corresponding to each pixel position; and

an outputting step of referring to a conversion table showing an relation of a output value to an input pixel value, the conversion table corresponding to the obtained threshold value, so as to obtain the multilevel output value corresponding to the extracted pixel value.

Preferably, the screen processing method further comprises: a position determining step of determining an output position within a dot in outputting a pixel of one dot based on the obtained multilevel output value, the output position being based on the multilevel output value of a pixel adjacent to the pixel to be output.

According to one embodiment reflecting the second aspect of the invention, a screen processing method comprises:

a scanning step of scanning an output object image in a main scanning direction and a sub scanning direction so as to extract watching pixels one by one;

a specifying step of converting scanning displacements in the main scanning direction and the sub scanning direction according to a screen angle so as to specify screen pixels corresponding to the watching pixels in a screen pattern from the converted scanning displacements; and

an outputting step of referring to the specified screen pixels so as to obtain output values of the watching pixels.

Preferably, the output values output at the outputting step are multilevel output values, and

the method further comprising: a position determining step of determining an output position within a dot in outputting a pixel of one dot based on the multilevel output values obtained at the output step, the output position being based on a multilevel output value of an pixel adjacent to the pixel to be output.

According to one embodiment reflecting the third aspect of the invention, an image processing apparatus, comprises:

two counters which counts scanning displacements in a main scanning direction and a sub scanning direction of an output image according to a screen angle, the two counters working with each other;

a storage unit which stores a conversion table showing a relation of a multilevel output value to an input pixel value, the conversion table corresponding to a threshold value of a pixel value; and

a screen processing unit which scans two-dimensionally arranged pixels in the main scanning direction and the sub scanning direction of the output object image so as to extract a pixel value of each pixel; discriminates each pixel position based on counted values of the counters so as to obtain a threshold value of a pixel value corresponding to each pixel position; and refers to a conversion table corresponding to the obtained threshold value among the conversion tables stored in the storage unit so as to obtain a multilevel output value corresponding to the extracted pixel value.

Preferably, the screen processing unit determines an output position within a dot in outputting a pixel of one dot based on the obtained multilevel output values, the output position being based on a multilevel output value of a pixel adjacent to the pixel to be output.

According to one embodiment reflecting the fourth aspect of the invention, an image processing apparatus comprises a screen processing unit which performs screen processing to an output object image,

wherein the screen processing unit; scans the output object image in a main scanning direction and a sub scanning direction so as to extract watching pixels one by one; converts scanning displacements in the main scanning direction and the sub scanning direction according to a screen angle so as to specify screen pixels corresponding to the watching pixels in a screen pattern from the converted scanning displacements; and refers to the specified screen pixels so as to obtain output values of the watching pixels.

Preferably, the output values output from the screen processing unit are multilevel output values, and

the screen processing unit determines an output position within a dot in outputting a pixel of one dot based on the multilevel output values, the output position being based on a multilevel output value of a pixel adjacent to the pixel to be output.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a diagram showing the internal configuration of an image processing apparatus according to the present embodiment;

FIG. 2 is a diagram showing the internal configuration of an image processing unit;

FIG. 3 is a diagram showing the internal configuration of an integration processing unit;

FIG. 4 is a diagram showing examples of screen patterns different in each color;

FIG. 5A is a diagram showing the screen pattern of a color material M (magenta);

FIG. 5B is a diagram showing an example of applying the screen pattern to an image;

FIG. 6 is a diagram showing an example of setting cells according to a screen pattern of rational tangent;

FIG. 7 is a figure showing counted values at each pixel position by a frequency dividing counter;

FIG. 8 is a diagram showing a flowchart illustrating screen processing;

FIG. 9 is a plotted diagram of a threshold value function;

FIG. 10 is a diagram showing conversion curves produced according to the value ranges of threshold values;

FIG. 11 is a diagram showing examples of γ tables which have been produced by tabling the conversion curves;

FIG. 12 is a diagram showing an example of setting cells according to a screen pattern of irrational tangent;

FIG. 13 is a diagram showing an example of an output image;

FIG. 14 is a diagram showing an example of a data configuration of a threshold value table; and

FIG. 15 is a diagram for illustrating the Holladay algorithm.

### DETAILED DESCRIPTION OF THE PREFERRED EMBODIMENTS

Hereinafter, the preferred embodiments according to a screen processing method and an image processing apparatus of the present invention are described with reference to the attached drawings.

In the present embodiment, an example of screen processing is described. The screen processing counts scanning displacements at the time of the main scanning and the sub scanning of watching pixels on an image using a counter which repeatedly performs counting in a certain range (hereinafter referred to as a frequency dividing counter), and calculates the threshold value of each pixel based on the counted value at each pixel position to determine the output value corresponding to a pixel value based on a γ table corresponding to the threshold value.

First, the configuration thereof is described.

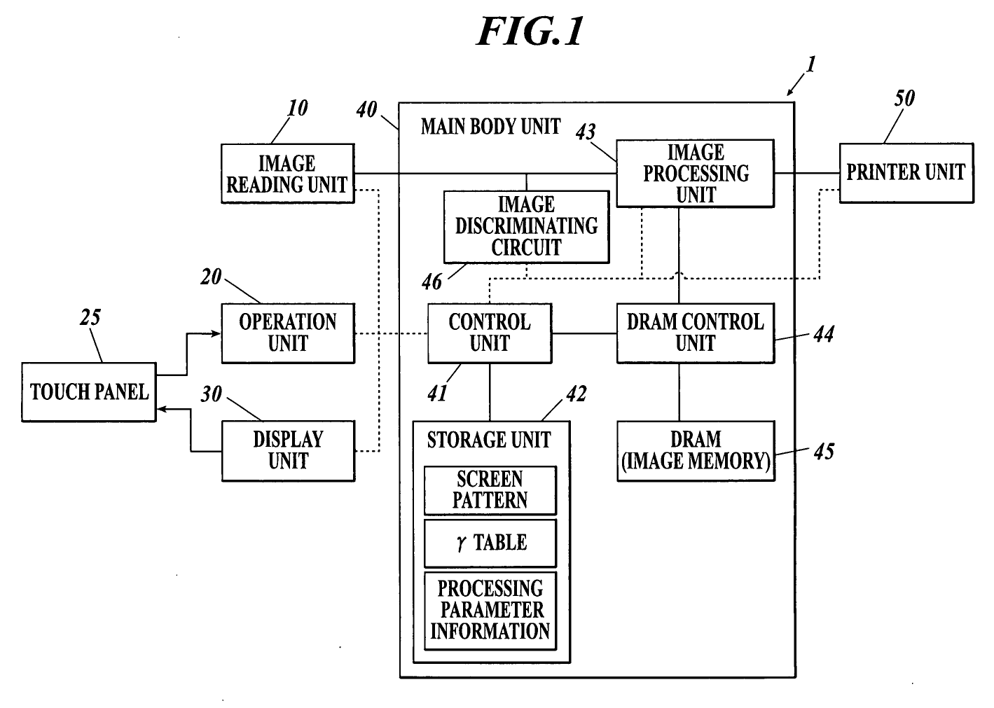

FIG. 1 shows the internal configuration of an image processing apparatus 1 in the present embodiment.

As shown in FIG. 1, the image processing apparatus 1 is composed of an image reading unit 10, an operation unit 20, a touch panel 25, a display unit 30, a main body unit 40 and a printer unit 50. Moreover, the main body unit 40 is composed of a control unit 41, a storage unit 42, an image processing unit 43, a dynamic random access memory (DRAM) control unit 44, a DRAM 45 and an image discriminating circuit 46. In the diagram, solid lines connecting each unit indicate system buses, and dotted lines indicate serial buses.

The image reading unit 10 is equipped with a light source, a charge coupled device (CCD) image sensor, an A/D converter, and the like. The image reading unit 10 performs the image formation of the reflected light of the light which has irradiated and scanned on a manuscript from a light source, and performs the photoelectric conversion of the formed image with the CCD image sensor to read the manuscript image. Then, the read image signal is converted into digital image data with an A/D converter. Here, an image contains not only image data, such as a figure and a photograph, but also text data, such as a character and a sign, and the like.

The operation unit 20 is equipped with various function keys such as a start key for instructing a start of a print, numeric keys and the like. When an function key or the touch panel 25 is operated, the operation unit 20 outputs a corresponding operation signal to the control unit 41.

The display unit 30 is equipped with a liquid crystal display (LCD) formed integrally with the touch panel 25, and makes the LCD display various operation screens thereon for performing a print operation.

Next, each unit of the main body unit 40 is described.

The control unit 41 performs the integrated control of the operation of each unit of the image processing apparatus 1 according to various control programs stored in the storage unit 42, such as a system program, a print processing program and the like.

The storage unit 42 stores various control programs, such as the system program, the print processing program and the like. Moreover, the storage unit 42 stores the information of the processing parameters applied at the time of averaging processing, the information of the processing parameters applied at the time of screen processing in the image processing unit 43, γ tables (the details about which will be described later.), and the like.

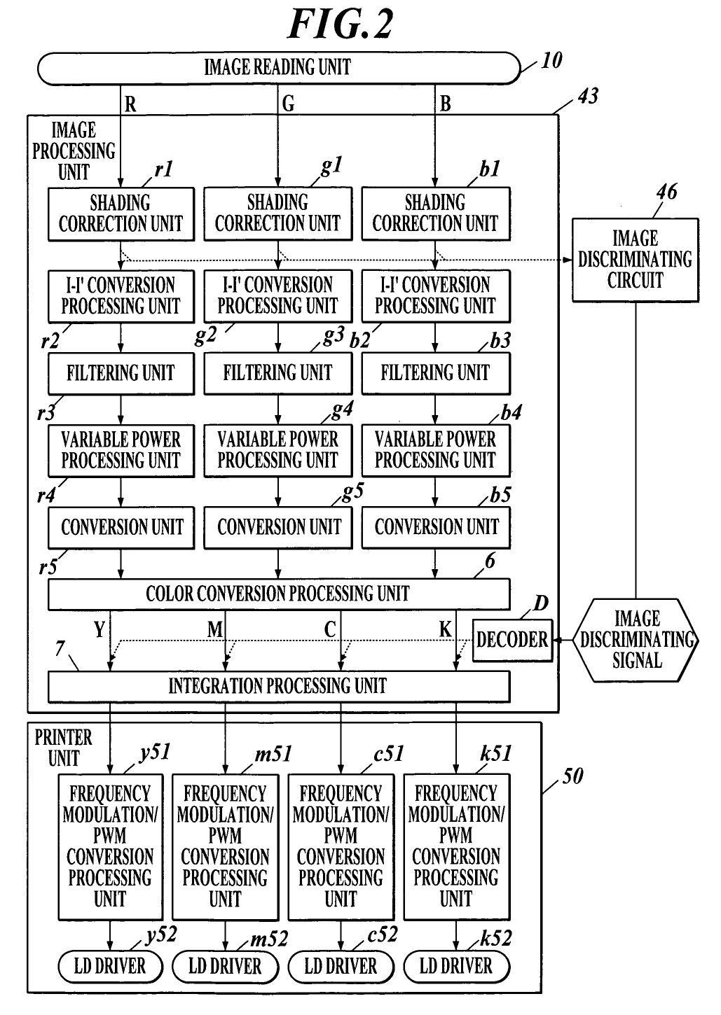

As shown in FIG. 2, the image processing unit 43 is composed of shading correction units r1, g1 and b1, I-I′ conversion processing units r2, g2 and b2, filtering units r3, g3 and b3, variable power processing units r4, g4 and b4, γ conversion units r5, g5 and b5, a color conversion processing unit 6, an integration processing unit 7 and a decoder D. The image processing unit 43 performs the image processing of image data of each color input after being separated into red (R), green (G) and blue (B), and outputs the processed image data to the printer unit 50.

The shading correction units r1, g1 and b1 correct luminance shading generated by the image reading unit 10. The shading correction units r1, g1 and b1 are previously equipped with look up tables (LUT's) for correcting luminance shading of each color of R, G and B, and perform the luminance conversion of the image data input with the LUT to perform a shading correction. Each image data which has received the shading correction is output to the I-I′ conversion processing units r2, g2 and b2, respectively.

The I-I′ conversion processing units r2, g2 and b2 are equipped with LUT's to each color of R, G and B for converting the luminance characteristic peculiar to the CCD of the image reading unit 10 into the optimum luminance characteristic according to the visual characteristic of a human being, and perform the luminance conversion of the image data input with the LUT's. Each image data which has received the luminance conversion is output to each of the filtering units r3, g3 and b3.

The filtering units r3, g3 and b3 perform the sharpening processing of the input image data using modulation transfer function (MTF) filters. Each image data having received the sharpening processing is output to each of the variable power processing units r4, g4 and b4.

The variable power processing units r4, g4 and b4 perform the expansion or the contraction of the input image data according to the specified output size, and change magnifications. Each image data having received the expansion or the contraction processing is output to the γ conversion units r5, g5 and b5.

The γ conversion units r5, g5 and b5 convert input image data using LUT's determining density linear output values to luminance linear input values, and convert the characteristics of the input image from the luminance linear characteristics to the density linear characteristics (the conversion is called as γ conversion processing). Each image data having received the γ conversion processing is output to the color conversion processing unit 6.

After the color conversion processing unit 6 has performed the color correction of each input image data of R, G and B, the color conversion processing unit 6 converts each of the color-corrected image data into each image data according to color materials Y, M, C and K which the image processing apparatus 1 can output. After each image data of Y, M, C and K generated by the color conversion has been temporarily stored in the DRAM 45, each image data is output to the integration processing-unit 7.

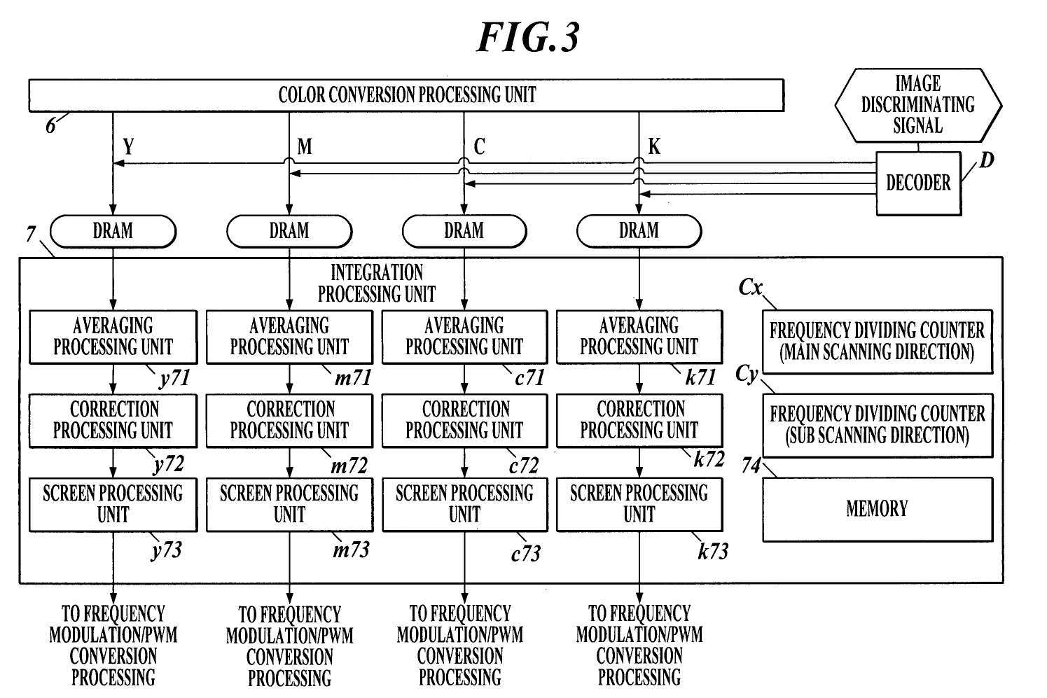

As shown in FIG. 3, the integration processing unit 7 is composed of averaging processing units y71, m71, c71 and k71, γ correction processing units y72, m72, c72 and k72, screen processing units y73, m73, c73 and k73, frequency dividing counters Cx and Cy, and a memory 74.

To the input image data, the averaging processing units y71, m71, c71 and k71 perform the averaging processing of calculating the average value of the pixel values in each certain region to replace the pixel values with the calculated average value. The image data having received the averaging processing is output to the γ correction processing units y72, m72, c72 and k72.

The γ correction processing units y72, m72, c72 and k72 perform the gradation conversion of the image data input using LUT's previously prepared for γ correction to perform γ correction processing. The image data of each color material which has received the γ correction processing is output to each of the screen processing units y73, m73, c73 and k73.

The frequency dividing counters Cx and Cy are counters which repeatedly perform counting within a certain range. Hereinafter, the certain range in which counting is repeatedly performed is referred to as a count range, and it is supposed that the lower limit value is zero and each of the upper limit values is XMAX (the upper limit value of the frequency dividing counter Cx) and YMAX (the upper limit value of the frequency dividing counter Cy). Incidentally, the count range can be suitably set according to the processing conditions of the averaging processing. The frequency dividing counters Cx and Cy work with each other to count scanning displacements every main scanning and sub scanning of pixels one by one in the screen processing units y73, m73, c73 and k73, and output their counted values to the screen processing units y73, m73, c73 and k73.

The memory 74 has a storage region for storing the processing results by the averaging processing units y71, m71, c71 and k71 and the screen processing units y73, m73, c73 and k73, and the like.

The screen processing units y73, m73, c73 and k73 set a cell which is a unit region according to a screen pattern to the image data of an output object when the image data is input therein. And the screen processing units y73, m73, c73 and k73 scan the image into the main scanning direction and the sub scanning direction by one pixel at a time to extract pixel values, and discriminate each pixel position based on the counted values counted by the frequency dividing counter Cx and Cy to calculate the threshold value corresponding to each of the pixel positions. And the screen processing units y73, m73, c73 and k73 obtain the γ table corresponding to the calculated threshold value from the memory 74, and obtains the output value corresponding to the extracted pixel value based on the γ table. When the output values have been finally determined about all the pixels, the screen processing units y73, m73, c73 and k73 generate the output image data to which the output values are set, and output the generated output image data to the printer unit 50.

First, screen patterns are described.

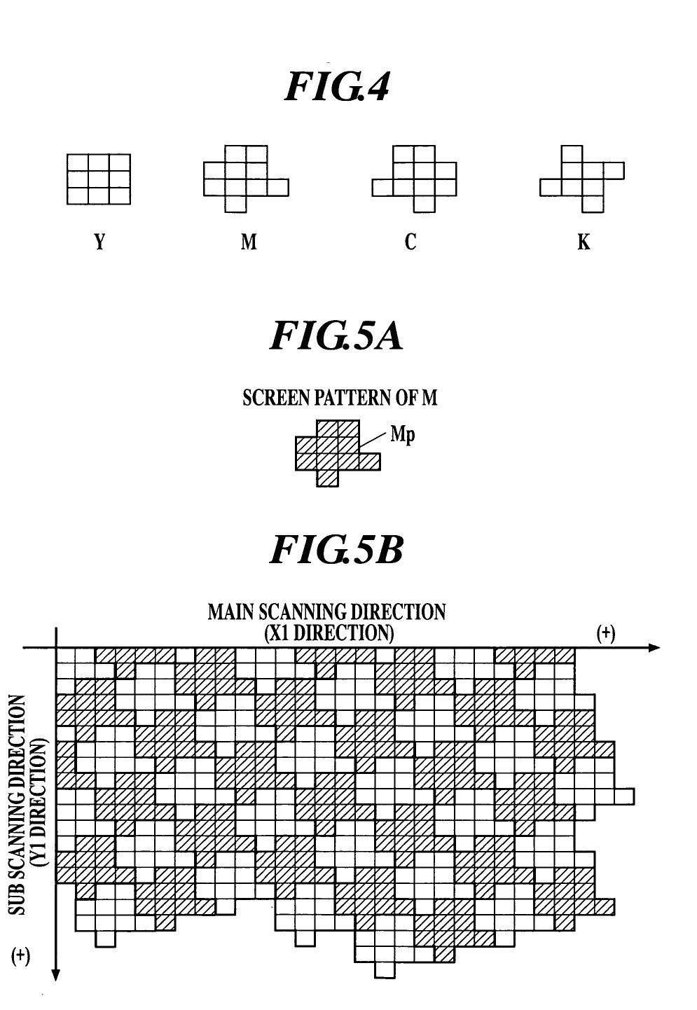

FIG. 4 is a diagram showing examples of the screen patterns for forming one halftone dot shape. Different shapes can be applied to the screen patterns according to each of the color materials Y, M, C and K.

In the present embodiment, the case of the color material M is exemplified to be described.

FIG. 5A is a diagram showing a screen pattern Mp for forming the halftone dot shape of the color material M. At the time of screen processing, the screen pattern Mp is applied on an image like a tile without any gaps, as shown in FIG. 5B. Incidentally, although there are hatched patterns and non-hatched patterns in FIG. 5B, the hatching is attached for making it easy to discriminate the adjoining screen patterns individually, and does not mean any differences in processing.

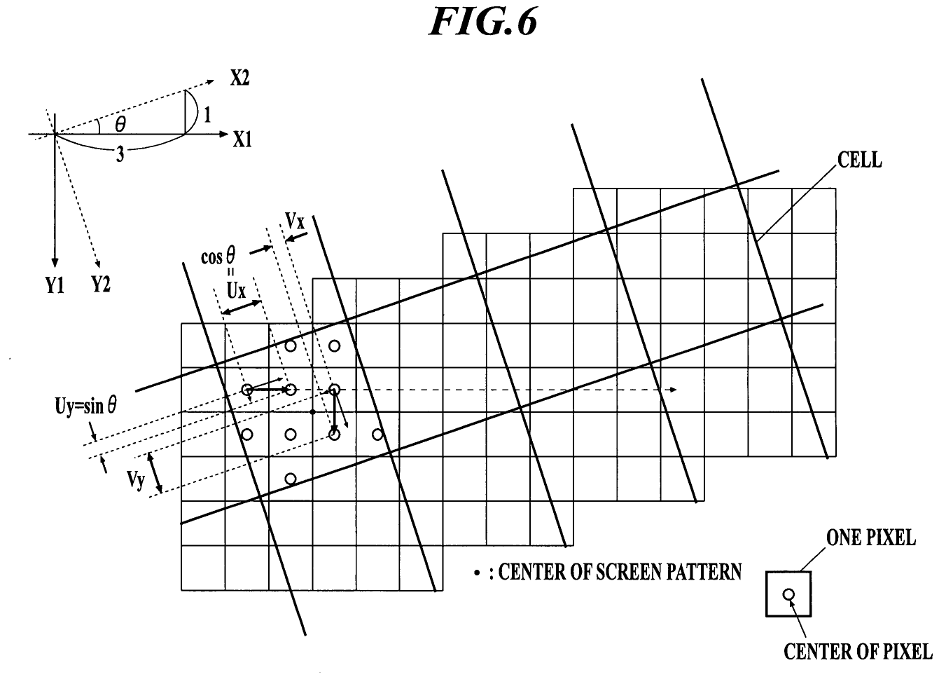

A cell is set to necessarily include the center point of the pixels constituting a screen pattern and not to include the center points of the other pixels in the cell according to the screen pattern. Moreover, a cell size indicating the size of a cell is indicated by the number of pixels constituting a screen pattern. In the case of the screen pattern Mp shown in FIG. 5A, the cell size is 10. As shown in FIG. 6, the screen pattern Mp can be set to have an inclination at which the screen angle becomes rational tangent to an orthogonal coordinate system composed of the main scanning direction and the sub scanning direction of an image, namely the inclination of either of the rational numbers of tan θ=±3, ±⅓. In the present embodiment, as shown in FIG. 6, it is supposed to set the cell at the inclination of − 1/3. Incidentally, in the diagram, the main scanning direction and the sub scanning direction constituting the coordinate system of the image are denoted by an X1 direction and a Y1 direction, respectively. Two directions constituting the orthogonal coordinate system of the cell set at the inclination of −⅓ to the coordinate system of the image are set as an X2 direction (corresponding to the X1 direction) and a Y2 direction (corresponding to Y1 direction). Moreover, an increment into each direction is denoted by a mark of “+”, and a decrement into each direction is denoted by a mark of “−.”

Next, the setting of a count unit in the frequency dividing counters Cx and Cy is described.

The frequency dividing counters Cx and Cy count the scanning displacements of pixels in the coordinate system (the orthogonal coordinate system composed of the X2 direction and the Y2 direction) of a cell. The unit which the frequency dividing counters Cx and Cy count the scanning displacements can be determined as follows.

The case of a screen pattern having a cell size N is considered. In this case, the cell can be virtually supposed to be a square having an area N, namely a virtual square having a length \sqrt{N} of one side by pixels, and a positional relation in which each pixel constituting the screen pattern is arranged on each of N lattice points in the virtual square can be supposed.

The coordinate system of the cells adopts a scale when one side of the virtual square is set to be 256.0, namely is scaled (proportionally converted) by being multiplied by 256.0/\sqrt{N}. In this case, when a distance for one pixel on an image is projected on the coordinate system of the cell, the length of the projected distance is equivalent to the length of each of the other two sides of the right-angled triangle having the hypotenuse of 256.0/\sqrt{N}. When it is supposed that the coordinate system of the cell is inclined by an angle θ to the coordinate system of the image, the lengths of the two sides can be expressed by a=256.0/\sqrt{10}×cos θ in the X2 direction and b=256.0/\sqrt{10}×sin θ, and the frequency dividing counters Cx and Cy count either ±a or ±b as an increment dependently on the set inclination of the cell.

As shown in FIG. 6, If the increment of the counted value of the frequency dividing counter Cx in the X2 direction is denoted by Ux and the increment of the counted value of the frequency dividing counter Cy in the Y2 direction is denoted by Uy when the screen pattern is moved for one pixel in the X1 direction on the image, Ux and Uy can be obtained by the following formulae (1) and (2).
Ux=+cos θ×256.0/\sqrt{10} (1)
Uy=+sin θ×256.0/\sqrt{10} (2)

Moreover, if it is supposed that the increment of the counted value of the frequency dividing counter Cx in the X2 direction is denoted by Vx and the increment of the counted value of the frequency dividing counter Cy in the Y2 direction is denoted by Vy when the screen pattern is moved for one pixel in the Y1 direction on the image, because the cell is a square in the present embodiment, Vx and Vy can be obtained by the following formulae (3) and (4).
Vx=−Uy (3)
Vy=+Ux (4)

Incidentally, although the count of the increments Ux and Uy is performed also including fractional parts, because the counter sets a finite number of digits of the fractional part, only the finite accuracy can be secured, and an error is produced at the least significant bit every count. Accordingly, it is necessary to secure the counter of the fractional part in order that the error produced every scanning for one pixel may fall into the digits after the decimal point even if counts are performed only for the number of pixels on one side of an image when the whole image is scanned. In view of practical use, the lengths a and b can be realized, for example, by a counter of 24 bits in the addition of its integer part and its fractional part. For example, even in the case of high resolution of 600 dpi and a rather large paper size of A3 size, the number of pixels constituting its long side of 420 mm is 9921 pixels, and even if the count is repeated by 9921 times, 14 bits are enough for making the errors fall into the fractional part. Consequently, if 16 bits can be secured as the fractional part, the errors can be made to fall in the fractional part sufficiently even in the case of the other paper sizes, and a counter of 24 bits composed of 8 bits of the inter part and 16 bits of the fractional part can be adopted.

In the present embodiment, because tan θ=−⅓, (Ux, Uy)=(+76.8, +25.6), and (Vx, Vy)=(−25.6, +76.8) from the formulae (1)-(4). And because the coordinate system of a cell is scaled so that one side of the virtual square may be 256.0, (XMAX, YMAX)=(256.0, 256.0).

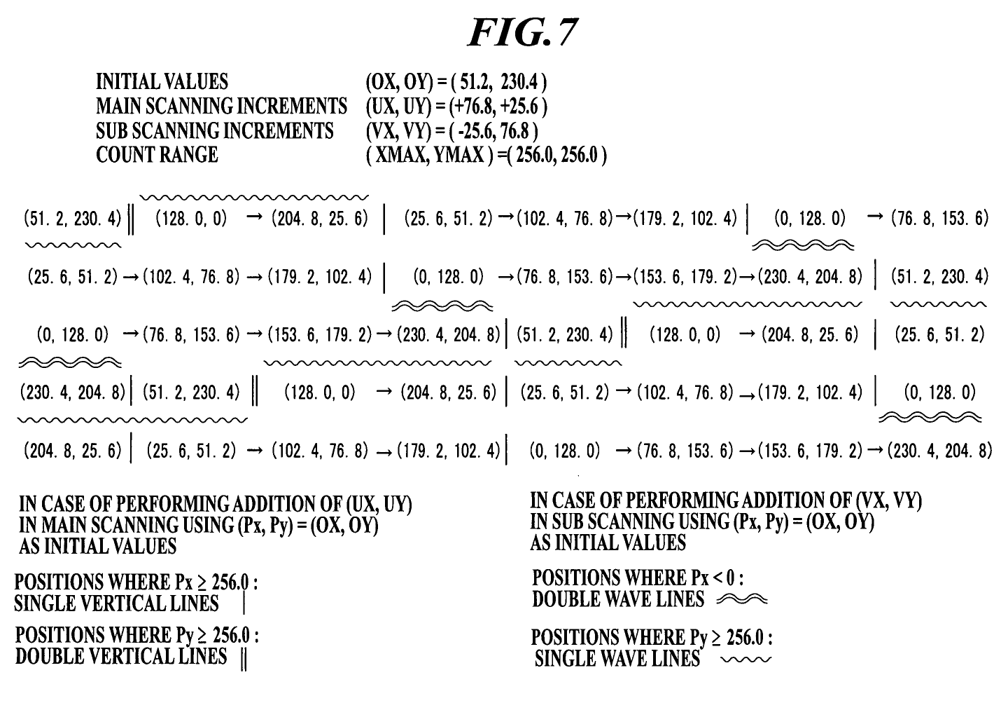

If the counted values of the frequency dividing counters Cx and Cy at the starting position from which the scanning of a watching pixel is started are supposed to be (Ox, Oy)=(51.2, 230.4), because the increments (Ux, Uy) are counted by (+76.8, +25.6) every main scanning by one pixel and the increments (Vx, Vy) are counted by (−25.6, +76.8) every sub scanning by one pixel, the counted values (Px, Py) of the frequency dividing counters Cx and Cy in each pixel position on an image become the values as shown in FIG. 7.

In this case, in the case where the counted value Px becomes XMAX (=256.0) or more to produce an overflow when the main scanning is performed by one pixel, a boundary (denoted by a single straight line in the figure) with the adjoining cell on the right side exists between the pixels before and after the scanning. In the case where the counted value Py becomes YMAX (=256.0) or more to produce an overflow, a boundary (denoted by a double straight line in the figure) with the adjoining cell below exists between the pixels. Moreover, in the case where the counted value Px becomes Px<0 to be below the lower limit of the count range to produce an underflow when the sub scanning is performed by one pixel, a boundary (denoted by a double wave line in the figure) with the adjoining cell on the left side exists between the pixels before and after the scanning. In the case where the counted value Py becomes YMAX (=256.0) or more to produce an overflow, a boundary (denoted by a single wave line in the figure) with the adjoining cell on the left side exists between the pixels.

The frequency dividing counters Cx and Cy are counters of 24-bit fixed decimal point composed of an 8-bit integer part and a 16-bit decimal part as mentioned above, and the range which the counted values Px and Py can take is a range of from the lower limit 0 to the upper limit (256-2ˆ16). In the case where a result of a count becomes blow 0 to produce an underflow or becomes 256 or more to produce an overflow, the digits above the 8 bits of the integer part are rounded down. Consequently, as a remainder system taking 256 as a divisor, the 8 bits of the integer part take the numbers in a range of from 0 to 255.

As described above, a region enclosed by each boundary line agrees with the screen pattern Mp of FIG. 5A, and the counted values (Px, Py) of a pixel position of each pixel constituting the screen pattern Mp are always the same counted values (Px, Py) in case of the pixel located at the same position in the screen pattern Mp. By the counted values (Px, Py), the pixel position of each pixel in a screen pattern can be discriminated.

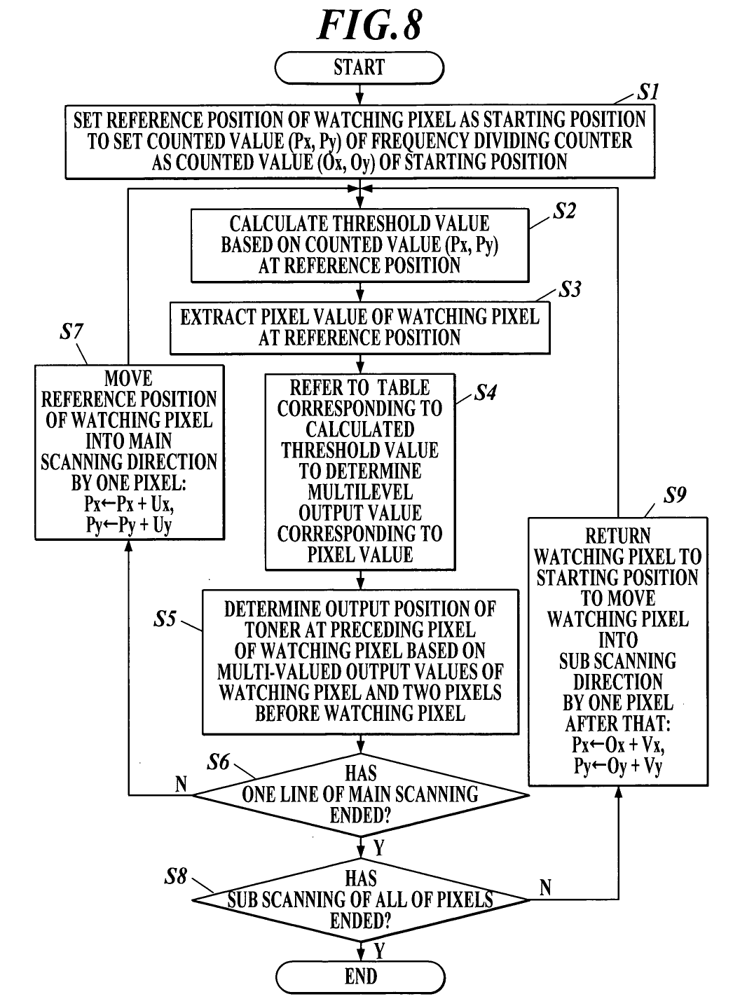

Next, a series of the flow of the screen processing executed by the screen processing unit m73 by the setting described above is described with reference to the flowchart of FIG. 8.

In the screen processing shown in FIG. 8, first, to the input image data, the screen processing unit m73 sets the reference position of an watching pixel at a starting position, and sets the counted values (Px, Py) of the frequency dividing counters Cx and Cy at the reference position at the counted values (Ox, Oy) of the starting position (Step S1). Subsequently, the screen processing unit m73 calculates a threshold value S(Px, Py) corresponding to the reference position based on the counted values (Px, Py) at the reference position (Step S2).

The threshold value S(Px, Py) can be calculated in conformity with the following formula (5).

$$S ( Px , Py ) = \{ 2 - cos ( π \cdot \frac{Px}{128} ) - cos ( π \cdot \frac{Py}{128} ) \} \times \frac{1}{4} \qquad ( 5 )$$

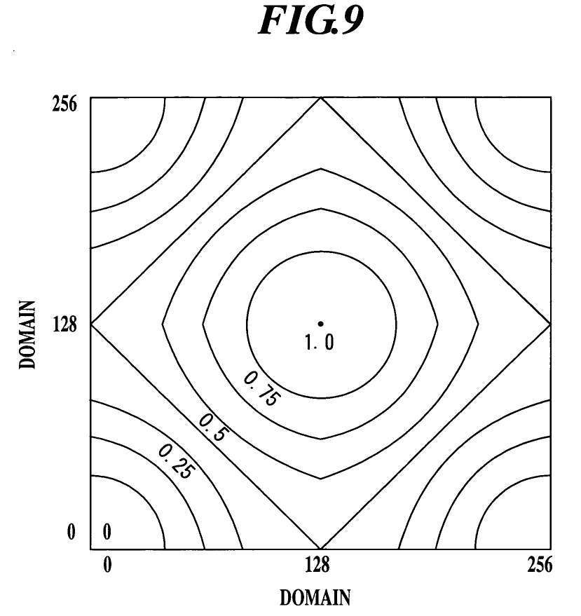

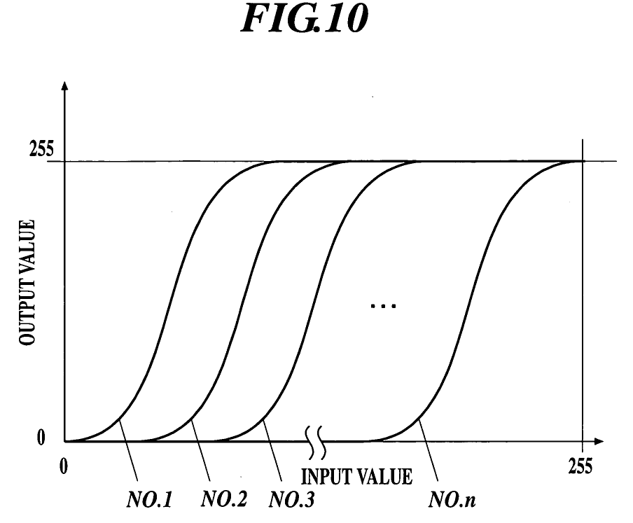

The formula is one called as a threshold value function, and is equivalent to one mountain of the concavo-convex shape, as shown in FIG. 9. FIG. 9 shows plotting the values of the threshold values S(Px, Py) in the shape of contour lines, and the value range of the threshold values S(Px, Py) is the range of from 0 to 1. Moreover, the domains which Px and Py can take are 0≦Px, Py<256, and are severally equivalent to one side of a cell. That is, the threshold value function S(Px, Py) is designed so as to take the maximum value 1 at the central part (Px, Py)=(128, 128) and the minimum values 0 at the four corners of the cell. Incidentally, the value range which the threshold value S(Px, Py) can take can be obtained by suitably performing scaling according to the number of gradation of the half tone to be expressed. For example, in the case of setting the threshold value S(Px, Py) as integer values in the range of from 0 to 255, the setting can be performed by multiplying the formula (5) by 256.

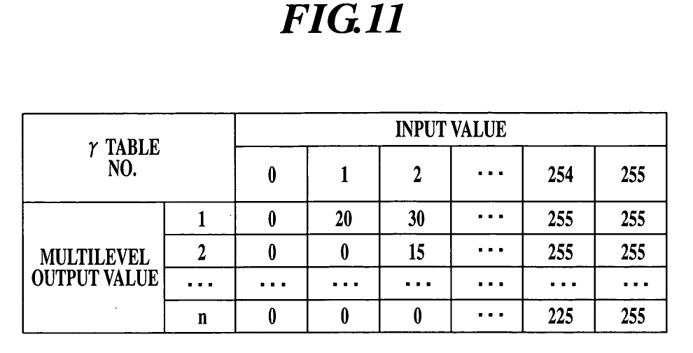

When the screen processing unit m73 has calculated the threshold value S(Px, Py), the screen processing unit m73 extracts the pixel value of the watching pixel at the reference position (Step S3). Subsequently, the screen processing unit m73 refers to a γ table corresponding to the threshold value calculated at Step S2. The γ table is a conversion table showing the relation of the multilevel output values of 0-255 corresponding to the input values of 0-255. A plurality of the γ tables is produced according to the threshold values, and a table number is given to each of the γ tables to be stored in the storage unit 42. To put it concretely, in the case of preparing n γ tables, as shown in FIG. 10, the value range of 0-255 of the threshold value is divided by n, and conversion curves (denoted by reference numerals of from No. 1 to No. n. The numbers agree with the table numbers of the γ tables) corresponding to the divided value ranges of the respective certain ranges are produced. Then, the γ tables produced by tabling the conversion curves as shown in FIG. 11 are stored in the storage unit 42.

Accordingly, the screen processing unit m73 refers to the γ table having the table number according to the value range corresponding to the calculated threshold value, and obtains the corresponding multilevel output value using the pixel value of the watching pixel which has been extracted at Step S3 as the input value (Step S4). Thus, the screen processing unit m73 determines the obtained multilevel output value as the final output value.

Subsequently, the screen processing unit m73 determines the output position of a toner at the preceding adjacent pixel to the watching pixel based on the multilevel output values of reference positions, namely the watching pixel and two adjacent pixels before the watching pixel (Step S5). In consideration of the fact that the output property of a toner becomes better in an electrophotography system when the irradiation of laser is made by a certain degree of continuous pulses of the laser, the laser irradiation position in a dot is determined to be any of placing the irradiation position to the right side, of placing it to the left side, and of placing it at the center. This is determined by means of three continuous multilevel output values in the main scanning direction.

For example, the case where the laser irradiation position is determined using the multi-value output values of the watching pixel and the adjacent pixels located on both sides of the watching pixel is described. In the case where the output value of the adjacent pixel on the left side is zero and the output value of the adjacent pixel on the right side is positive, the laser irradiation position at the watching pixel is set to the placing of the irradiation position on the right side. Moreover, in the case where the output value of the adjacent pixel on the left side is positive and the output value of the adjacent pixel on the right side is zero, the laser irradiation position at the watching pixel is set to the placing of the irradiation position on the left side. In the case where the output values of the adjacent pixels on both sides are zero, the laser irradiation position at the watching pixel is set to the placing of the irradiation at the center. Moreover, in the case where the output values of the adjacent pixels on both sides are positive, the output values are compared with the output value of the watching pixel. Then, when the output value of the watching pixel is the maximum, the laser irradiation position is determined to the center. When either of the output values of the both adjacent pixels on the right side and the left side is larger than the output value of the watching pixel, the laser irradiation position is determined to place the irradiation position to the side of the adjacent pixel of the larger output value.

Thereby, the output position of the toner is placed to the center of the screen pattern as a result. Incidentally, the position control is not limited to the method disclosed above, the arrangement of dots in three or more continuous pixels may be considered, or, for example, in the case of single isolated point, placing the laser irradiation position to the right side or to the left side in consideration of the center position of halftone dots may be adopted without placing it to the center uniformly.

When the screen processing unit m73 has determined the multilevel output value and the output position of the toner as for the watching pixel in this way, the screen processing unit m73 discriminates whether the main scanning for one line has been completed or not. In case of not completed yet (No at Step S6), the screen processing unit m73 moves the reference position of the watching pixel into the main scanning direction for one pixel. With the movement for one pixel, the frequency dividing counters Cx and Cy add (Ux, Uy) to the counted values (Px, Py) to count the scanning displacements (Step S7). Then, the screen processing unit m73 returns its processing to the processing at Step S2, and the screen processing unit m73 repeats the processing of determining the multilevel output value and the output position according to the pixel position of the watching pixel after the movement until the completion of the scanning for one line.

On the other hand, when the main scanning for one line has been completed (Yes at Step S6), the screen processing unit m73 discriminates whether the sub scanning has been completed to all the pixels or not (Step S8). When the sub scanning has not been completed to all the pixels (No at Step S8), the screen processing unit m73 moves the watching pixel to the starting position of the main scanning before the screen processing unit m73 moves the watching pixel in the sub scanning direction by one pixel. With the movement, the frequency dividing counters Cx and Cy set the counted value (Ox+Vx, Oy+Vy) produced by adding (Vx, Vy) to the counted value (Ox, Oy) at the starting position as the counted values (Px, Py) at the reference position of the watching pixel (Step S9). Subsequently, the screen processing unit m73 moves its processing to the processing at Step S2, and the screen processing unit m73 repeats the processing of Steps S2-S7 to the pixels on the main scanning line which has moved in the sub scanning direction by one pixel.

On the other hand, in the case where the sub scanning has been completed to all the pixels (Yes at Step S8), namely in the case where the scanning has been completed about all the pixels existing in the main scanning direction and the sub scanning direction, the screen processing unit m73 ends the present processing, and outputs the processed image data having the determined multilevel output values as the pixel values of all the pixels and output control information instructing the output positions of a toner to the printer unit 50.

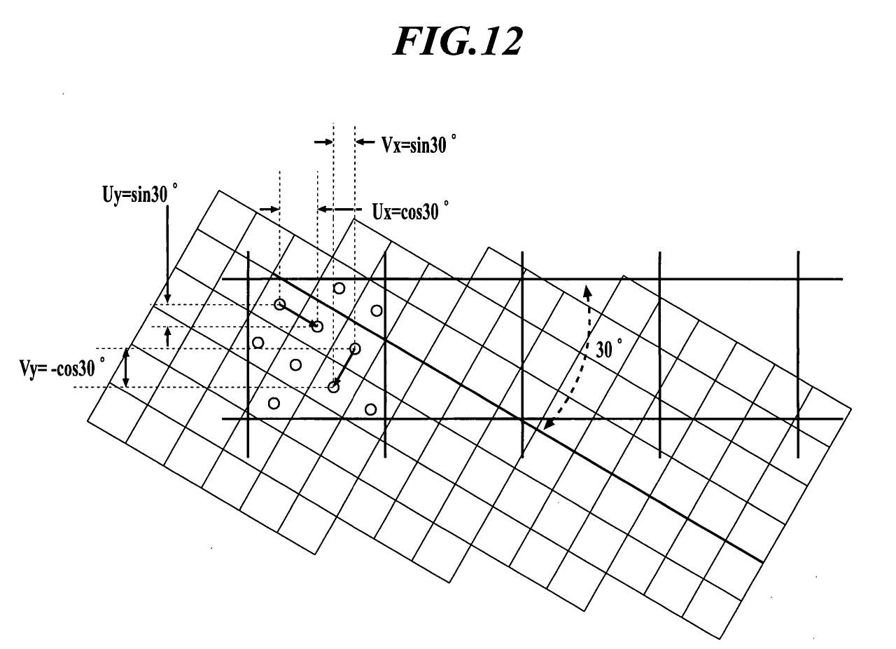

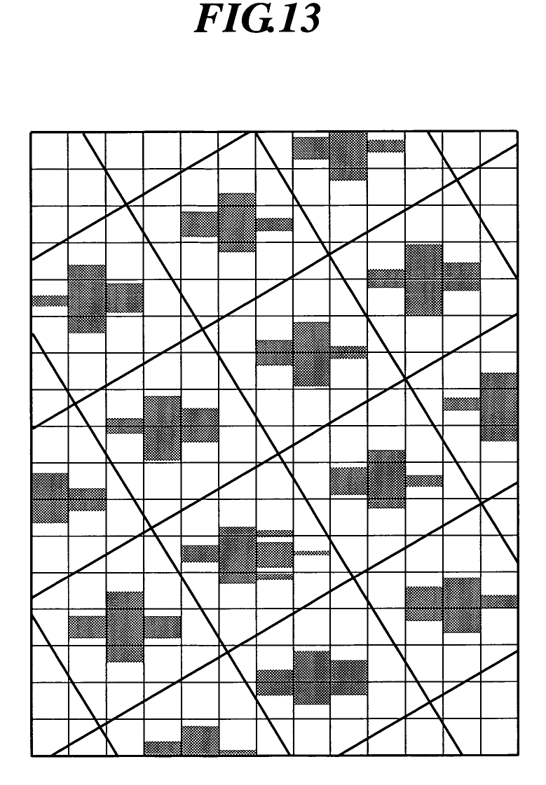

Incidentally, although a screen pattern in which the screen angle is rational tangent has been described as an example in the present embodiment, the screen pattern is not limited to that one. As shown in FIG. 12, the present invention can be applied to the case of the screen pattern in which the screen angle is irrational tangent. The screen pattern shown in FIG. 12 has a shape arranged by irrational tangent of a screen angle of 30°. When a virtual square having one side of \sqrt{10} by the unit of the interval of pixels and a line segment for one pixel in the main scanning direction is projected to the coordinate system of a cell, (Ux, Uy)=(cos30°, sin30°) If the scaling of \sqrt{10} to 256.0 is performed, Ux and Uy can be severally expressed by the following formulae (6) and (7).
Ux=+256.0×cos30°/\sqrt{10} (6)
Uy=+256.0×sin30°/\sqrt{10} (7)

As described above, as for the Ux and the Uy, by calculating necessary count ranges in advance at the accuracy of necessary resolution from the pixel numbers in one page of a piece of printing paper as constants, the Ux and the Uy can be processed after that only by addition calculations. Thereby, the processing becomes the processing independent of whether the screen angle is rational tangent or whether the screen angle is irrational tangent.

Moreover, because the shape is a square, the Vx and the Vy corresponding to the length for one pixel in the sub scanning direction can be obtained from the following formulae (8) and (9) by rotating the Ux and Uy by 90°.
Vx=+Uy (8)
Vy=−Ux (9)

At the time of the main scanning and the sub scanning of the watching pixels, similarly to the case of the rational tangent, the count of the frequency dividing counters Cx and Cy is performed by the increments Ux, Uy, Vx and Vy described above, and the threshold value S(Px, Py) is calculated based on the counted values (Px, Py). Thereby, the threshold values according to the pixel position in a screen pattern can be obtained.

The DRAM control unit 44 controls the input and the output of the image data stored in the DRAM 45.

The DRAM 45 is an image memory storing image data.

The image discriminating circuit 46 performs the data analysis of image data read and input by the image reading unit 10 to discriminate a character region as a specific region, and generates an image discrimination signal. Alternatively, the image discriminating circuit 46 performs the edge detection of image data to discriminate the detected edge region as a specific region, and performs the generation of the image discrimination signal and the like. Thus, the image discriminating circuit 46 generates the image discrimination signal of the image data, which is an output object, and outputs the image discrimination signal to the image processing unit 43.

The printer unit 50 performs the color print output of Y, M, C and K by the electrophotography system. The printer unit 50 is composed of an exposure unit, which is equipped with a laser device (LD) driver, a laser light source and the like to form a latent image on a photosensitive drum, a development unit forming an image by blowing a toner on the photosensitive drum, a transfer belt transferring the toner on the photosensitive drum having received the image formation thereon onto a sheet of print paper, and the like. Incidentally, another print system may be applied.

When processing image data and output control information are input from the screen processing units y73, m73, c73 and k73 into the printer unit 50, according to the output control information, the printer unit 50 performs frequency modulation and pulse width modulation (PWM) conversion with the frequency modulation/PWM conversion processing units y51, m51, c51 and k51 based on the processing image data, and inputs the modulated laser drive pulse into the LD driver. The LD driver drives the laser light source based on the input laser drive pulse, and radiates laser light from the laser light source.

Thereby, the toner is output to an output position determined in a dot for an area according to the determined multilevel output value.

An example of an output image is shown in FIG. 13. In the example shown in FIG. 13, as for each dot constituting a screen pattern, the toner is output to be collected to the center side of the screen pattern in an area according to the multilevel output value. Thereby, the output of the toner concentrates to the center of a halftone dot, and it is known that the halftone dot shape is stable. Moreover, by the output position control of the toner, the output is performed so that the output positions may adjoin to each other when two pixels are continuously output, and so that only the output position of the center pixel may be the center of the pixel and toner may concentrate between adjoining pixels when three pixels are continuously output. Thereby, the output of the toner can be continuously performed to make the output efficiency better.

In FIG. 13, because the angle formed by the virtual square is irrational tangent, the relative positional relation with the pixel position of the original image changes one by one, and each halftone dot shape becomes delicately different. Consequently, the generation of moiré of a fixed pattern produced by the repetition of the overlapping method of the same dots at a certain period in the case of the rational tangent can be suppressed.

Although an angle near irrational tangent is realized by the conventional method disclosed in JP 2000-228728A, the method still produces the screen of the repetitive pattern of a fixed size such as 12×12, and it is not avoided that the moiré occurs at a certain period of the least common multiple period among each color.

Moreover, by the conventional method disclosed in JP 2001-61072A, the scanning direction of a laser is supposed to be made to be 15°, 75° or the like in order to realize irrational tangent. The present invention uses the counter securing sufficient calculation accuracy by a method different from that of the prior art, and shows the method of realizing the screen of irrational tangent. The present invention has an advantage capable of freely selecting any of the screen angles of rational tangent and irrational tangent only by changing the setting of the increments of the counter. Moreover, the present invention can thereby contribute to the suppressing of a moiré pattern which is generated at a certain period in case of the rational tangent and has been pointed out by JP 2001-61072A.

As described above, according to the present embodiment, the frequency dividing counters Cx and Cy count the scanning displacements of watching pixels in the coordinate system of a cell inclined by a screen angle, and the present embodiment distinguishes the pixel position of each pixel which exists in two dimensions on an image from the counted value. Then, the present embodiment calculates the threshold value according to the pixel position. And, the present embodiment refers to a γ table corresponding to the threshold value to obtain a multilevel output value. Consequently, the present embodiment can easily assign the multilevel output value according to a pixel position independent of whether the screen angle of the halftone dot to be formed is rational tangent or whether the screen angle is irrational tangent. Therefore, it is not necessary to take a screen angle into consideration, and the degree of freedom of the design of screen pattern shapes can be improved.

Moreover, because the present embodiment can easily discriminate the position of a watching pixel to the center of a screen pattern from a counted value, the present embodiment can easily determine an output position so that a toner may be output to the center side of the screen pattern. Thereby, the present embodiment can concentrate the output positions of the toner and the like in a series of continuous pixels of the adjoining pixels or the like. Moreover, by performing such output control, the present embodiment can perform an output so as to place the output position to the center side of the screen pattern, and can put the halftone dot shape formed by the screen pattern in order.

Moreover, because the output property is better at the time of performing continuous output when a print system is based on an electrophotography system, it is possible to enable the continuous output to improve the output property of a toner by centralizing the output positions of the toner on the center side of a plurality of pixels. Although there is a difference of a degree depending on a printer, there is the characteristic that a pulse response is improved to a continuous output and the output of a toner becomes good, on the other hand the pulse response is slow and the toner is hard to be output to a discontinuous output. Accordingly, by performing output control so as to place the output positions to the center of a plurality of certain continuous pixels in each of the pixels as much as possible, the continuity of the toner output can be maintained and the output state of the toner becomes better.

Moreover, because a plurality of γ tables is prepared according to the value ranges of threshold values, the present embodiment can be configured to be easy to output the toner even when an input value is small in the case where the threshold value is small, and to be difficult to output the toner even when an input value is larger in the case where the threshold value is large. Consequently, the present embodiment can output a multilevel output value according to the threshold value.

Moreover, because the present embodiment sequentially execute the processing of calculating a threshold value to determine an output value while performing the main scanning and the sub scanning by one pixel at a time, one-dimensional or two-dimensional screen processing becomes possible with a simple configuration.

Furthermore, because the present embodiment calculates a threshold value based on a counted value, it is unnecessary to be provided with the data of the threshold value corresponding to each pixel position in advance. Moreover, even when the shapes and the sizes of screen patterns differ from one another, the processing parameters of the screen patterns can be communalized. Consequently, the configuration at the time of screen processing can be simplified. In the case where the data of the threshold values are prepared in advance, the data of each threshold value must be prepared according to the shape of a screen pattern, and the processing of discriminating the threshold values to be referred to also becomes necessary.

Incidentally, the image processing apparatus 1 in the present embodiment is a suitable example to which the present invention is applied, and the image processing apparatus is not limited to that one.

Although in the embodiment described above the threshold value S(Px, Py) is calculated from counted values (Px, Py) each time, as shown in FIG. 11, each pixel in a screen pattern takes a peculiar counted values (Px, Py) according to the pixel position. Consequently, it is possible to discriminate each pixel position within a screen pattern from the peculiar counted value. Therefore, a threshold value table which has set the threshold values beforehand to the counted values (Px, Py) may be provided, and the threshold values corresponding to the counted values (Px, Py) of a watching pixel may be referred to from the threshold value table at the time of screen processing.

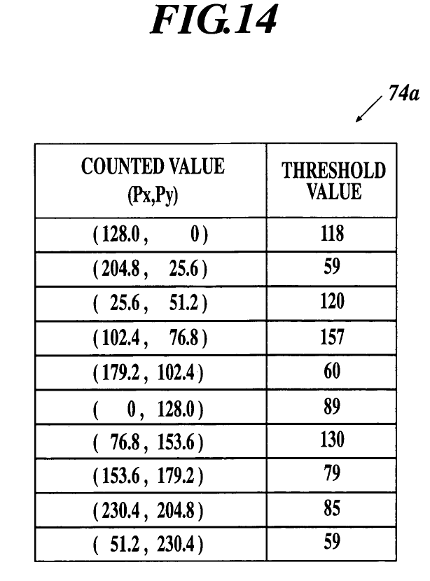

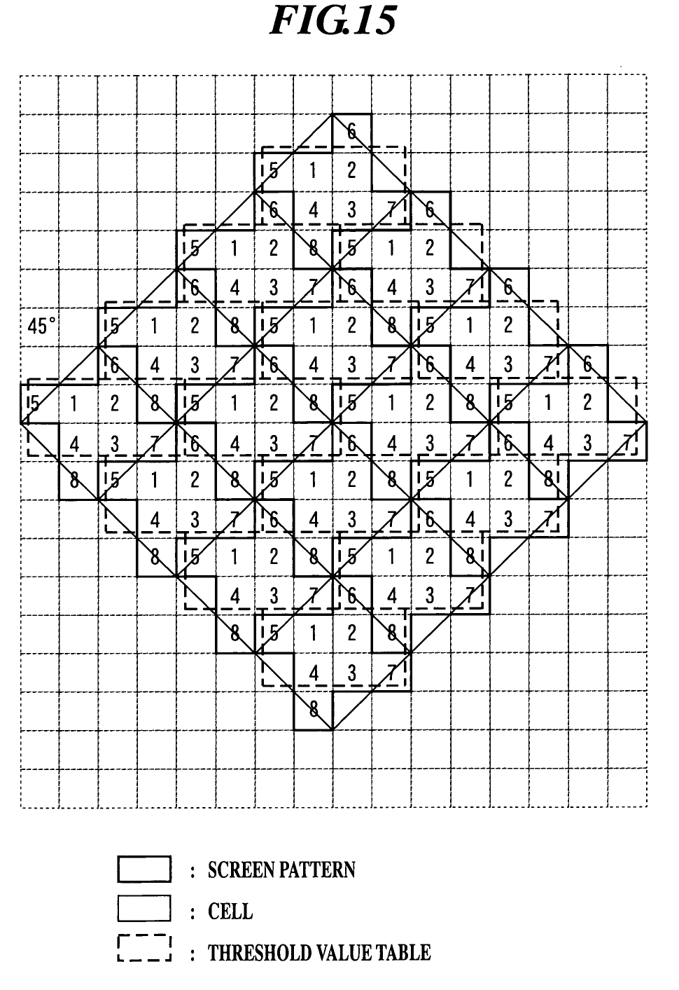

For example, a threshold value table 74a shown in FIG. 14 is previously stored in the memory 74. In the threshold value table 74a, a threshold value (for example, “118”) calculated beforehand is set to the counted values (for example, counted values “(128.0, 0)”) in each pixel position in a screen pattern. At the time of screen processing, after setting an watching pixel at a starting position and setting (Ox, Oy) as counted values (Px, Py), the counted values (Px, Py) at the pixel position of the watching pixel are referred to every displacement in the main scanning direction and the sub scanning direction by one pixel at a time, and a threshold value corresponding to the counted values (Px, Py) is read from the threshold value table 74a. Thus, by preparing the threshold value table 74a in advance, a threshold value according to a pixel position can be easily obtained without calculating the threshold value from the counted values one by one.

The present U.S. patent application claims a priority under the Paris Convention of Japanese patent application No. 2005-027887 filed on Feb. 3, 2005, and is entitled to the benefit thereof for a basis of correction of an incorrect translation.

What is claimed is:

1. A screen processing method, comprising:
a scanning step of scanning two-dimensionally arranged pixels of an output object image in a main scanning direction and a sub scanning direction so as to extract a pixel value of each pixel;
a thresholding step of counting scanning displacements in the main scanning direction and the sub scanning direction according to a screen angle by using two counters working with each other, and of discriminating each pixel position based on counted values of the counting so as to obtain a threshold value of the pixel value corresponding to each pixel position; and
an outputting step of referring to a conversion table showing an relation of a output value to an input pixel value, the conversion table corresponding to the obtained threshold value, so as to obtain the multilevel output value corresponding to the extracted pixel value.

2. The screen processing method of claim 1, further comprising: a position determining step of determining an output position within a dot in outputting a pixel of one dot based on the obtained multilevel output value, the output position being based on the multilevel output value of a pixel adjacent to the pixel to be output.

3. A screen processing method, comprising:
a scanning step of scanning an output object image in a main scanning direction and a sub scanning direction so as to extract watching pixels one by one;
a specifying step of converting scanning displacements in the main scanning direction and the sub scanning direction according to a screen angle so as to specify screen pixels corresponding to the watching pixels in a screen pattern from the converted scanning displacements; and
an outputting step of referring to the specified screen pixels so as to obtain output values of the watching pixels.

4. The screen processing method of claim 3,
wherein the output values output at the outputting step are multilevel output values, and
the method further comprising: a position determining step of determining an output position within a dot in outputting a pixel of one dot based on the multilevel output values obtained at the output step, the output position being based on a multilevel output value of an pixel adjacent to the pixel to be output.

5. An image processing apparatus, comprising:
two counters which counts scanning displacements in a main scanning direction and a sub scanning direction of an output image according to a screen angle, the two counters working with each other;
a storage unit which stores a conversion table showing a relation of a multilevel output value to an input pixel value, the conversion table corresponding to a threshold value of a pixel value; and
a screen processing unit which scans two-dimensionally arranged pixels in the main scanning direction and the sub scanning direction of the output object image so as to extract a pixel value of each pixel; discriminates each pixel position based on counted values of the counters so as to obtain a threshold value of a pixel value corresponding to each pixel position; and refers to a conversion table corresponding to the obtained threshold value among the conversion tables stored in the storage unit so as to obtain a multilevel output value corresponding to the extracted pixel value.

6. The image processing apparatus of claim 5, wherein
the screen processing unit determines an output position within a dot in outputting a pixel of one dot based on the obtained multilevel output values, the output position being based on a multilevel output value of a pixel adjacent to the pixel to be output.

7. An image processing apparatus, comprising a screen processing unit which performs screen processing to an output object image,
wherein the screen processing unit; scans the output object image in a main scanning direction and a sub scanning direction so as to extract watching pixels one by one; converts scanning displacements in the main scanning direction and the sub scanning direction according to a screen angle so as to specify screen pixels corresponding to the watching pixels in a screen pattern from the converted scanning displacements; and refers to the specified screen pixels so as to obtain output values of the watching pixels.

8. The image processing apparatus of claim 7,
wherein the output values output from the screen processing unit are multilevel output values, and
the screen processing unit determines an output position within a dot in outputting a pixel of one dot based on the multilevel output values, the output position being based on a multilevel output value of a pixel adjacent to the pixel to be output.
